(19) United States
(12) Patent Application Publication
(10) Pub. No.: US 2009/0010141 A1
(43) Pub. Date: Jan. 8, 2009

(54) Optical pickup apparatus and objective lens

(75) Inventor: Fumio Nagai, Tokyo (JP)

Correspondence Address: COHEN, PONTANI, LIEBERMAN & PAVANE LLP, 551 FIFTH AVENUE, SUITE 1210, NEW YORK, NY, 10176, US

(73) Assignee: Konica Minolta Opto, Inc., Tokyo (JP)

(21) Appl. No.: 12/217,448

(22) Filed: Jul. 3, 2008

(30) Foreign Application Priority Data
Jul. 6, 2007 (JP) JP2007-178214

(51) Int. Cl. G11B 7/00

(52) U.S. Cl. 369/112.23

(57) ABSTRACT

An optical pickup apparatus is provided for recording and/or reproducing information on an optical disc including at least one reference layer and at least one recording layer in which information can be recorded at recording positions each located at a different distance from an optical disc surface. The optical pickup apparatus includes: a light source; a relay lens system for emitting a converged light flux; an objective lens arranged at a predetermined distance from the reference layer, for converging the converged light flux onto one of the recording positions; and a photodetector. The relay lens system changes a convergence angle of the converged light flux to enter the objective lens by moving in a direction of an optical axis thereof so as to select a recording position where information is recorded and/or reproduced.

This application is based on Japanese Patent Application No. 2007-178214 filed on Jul. 6, 2007, in Japanese Patent Office, the entire content of which is hereby incorporated by reference.

### TECHNICAL FIELD

The present invention relates to an optical pickup apparatus capable of recording information and/or reproducing information on an optical disc, and to an objective lens that is used for the optical pickup apparatus.

### BACKGROUND

There has been made a study of development rapidly for a high density optical disc apparatus capable of recording and/or reproducing (hereinafter referred to as “recording/reproducing”) information, by using a violet semiconductor laser having a wavelength of about 400 nm. As an example, there is provided an optical disc recording/reproducing information under the specifications including NA (numerical aperture) of 0.65 and a light source wavelength of 405 nm, namely, so-called HD DVD (hereinafter referred to as HD). In HD, information of about 15 GB per one layer can be recorded when the optical disc has a diameter of 12 cm. Further, as another example, there is provided an optical disc recording/reproducing information under the specifications including NA of 0.85 and a light source wavelength of 405 nm, namely, so-called Blu-ray Disc (hereinafter referred to as BD). In BD, information of about 25 GB per one layer can be recorded when the optical disc has a diameter of 12 cm. Hereafter, these optical discs are called “high density optical disc”.

Incidentally, there has been developed an optical disc including a plurality of recording layers for further increasing a storage capacity. In the optical disc of this kind, there is recorded information representing the number of layers on the plural recording layers. Therefore, in the optical pickup apparatus corresponding to this optical disc, a recording layer that has recorded and/or reproduced information is selected by reading the aforesaid information from the optical disc, and thereby, the objective lens is moved in accordance with the foregoing. Thus, a light flux emitted from the light source is converged on the recording layer. More specifically, Unexamined Japanese Patent Application Publication (JP-A) No. 5-266511 discloses an example such that a beam expander is displaced in the optical axis direction to correct spherical aberration caused by a thickness difference between substrates. JP-A 11-259893 discloses an example such that displacing a collimator lens in the optical axis direction corrects spherical aberration caused by a thickness difference between substrates.

### SUMMARY

When recording information on a plurality of recording positions each having a different depth from the surface of the disc, spherical aberration is generated because a thickness of a substrate from the surface to the recording position is different from others. When correcting spherical aberration caused by a difference of substrate thickness by making fine adjustments for positions of a beam expander and a collimator lens in the optical axis direction, and thereby, by changing an incidence angle of a light flux entering an objective lens, there is a problem that caused spherical aberration is hard to be corrected sufficiently. In particular, when a distance between the recording surfaces large like a multi-layer disc, spherical aberration caused by the difference between substrate thicknesses becomes massive, and it is hardly corrected sufficiently.

The present invention is achieved in view of problems in the conventional technologies mentioned above, and an object is to provide an optical pickup apparatus capable of recording and/or reproducing information accurately under the condition that aberrations are corrected appropriately for various recording positions which are different with each other along the optical axis of an optical disc, and to provide an objective lens to be used in the optical pickup apparatus.

An optical pickup apparatus relating to the present invention is an optical pickup apparatus for recording and/or reproducing information on an optical disc comprising at least one reference layer and at least one recording layer in which information can be recorded at a plurality of recording positions each located at a different distance from a surface of the optical disc. The optical pickup apparatus comprises: a light source for emitting a light flux; a relay lens system for receiving the light flux emitted from the light source and emitting a converged light flux; an objective lens arranged at a predetermined distance along an optical axis from the reference layer, for converging the converged light flux from the relay lens system onto one of the plurality of recording positions; and a photodetector for receiving a light flux emitted from the optical disc. In the optical pickup apparatus, the relay lens system changes a convergence angle of the converged light flux to enter the objective lens by moving in a direction of an optical axis thereof so as to select a recording position where information is recorded and/or reproduced.

These and other objects, features and advantages according to the present invention will become more apparent upon reading of the following detailed description along with the accompanied drawings.

### BRIEF DESCRIPTION OF THE DRAWINGS

Embodiments will now be described, by way of example only, with reference to the accompanying drawings which are meant to be exemplary, not limiting, and wherein like elements numbered alike in several Figures, in which:

FIG. 1 is a diagram schematically showing a light flux that passes through an objective lens and is converged in a recording position in an optical disc;

FIG. 2 is a diagram schematically showing the structure of optical pickup apparatus PU1;

FIG. 3 is a graph showing an amount of spherical aberration for the recording position of an optical disc relating to Comparative Example 1;

FIG. 4 is a graph showing m·NA for the recording position of an optical disc relating to Comparative Example 1;

FIG. 5 is a graph showing an amount of spherical aberration for the recording position of an optical disc relating to Comparative Example 2;

FIG. 6 is a graph showing m·NA for the recording position of an optical disc relating to Comparative Example 2;

FIG. 7 is a diagram on which relationship between m·NA and third order spherical aberration is plotted for Comparative Examples 1 and 2;

FIG. 8 is a graph showing an amount of spherical aberration for the recording position of an optical disc relating to Example 1;

FIG. 9 is a graph showing m·NA for the recording position of an optical disc relating to Example 1.

FIG. 10 is a graph showing an amount of spherical aberration for the recording position of an optical disc relating to Example 2;

FIG. 11 is a graph showing m·NA for the recording position of an optical disc relating to Example 2;

FIG. 12 is a graph showing an amount of spherical aberration for the recording position of an optical disc relating to Example 3;

FIG. 13 is a graph showing m·NA for the recording position of an optical disc relating to Example 3;

FIG. 14 is a graph showing an amount of spherical aberration for the recording position of an optical disc relating to Example 4;

FIG. 15 is a graph showing m·NA for the recording position of an optical disc relating to Example 4;

FIG. 16 is a graph showing an amount of spherical aberration for the recording position of an optical disc relating to Example 5;

FIG. 17 is a graph showing m·NA for the recording position of an optical disc relating to Example 5;

FIG. 18 is a graph showing an amount of spherical aberration for the recording position of an optical disc relating to Example 6;

FIG. 19 is a graph showing m·NA for the recording position of an optical disc relating to Example 6;

FIG. 20 is a graph showing an amount of spherical aberration for the recording position of an optical disc relating to Example 7;

FIG. 21 is a graph showing m·NA for the recording position of an optical disc relating to Example 7;

FIG. 22 is a graph showing an amount of spherical aberration for the recording position of an optical disc relating to Example 8;

FIG. 23 is a graph showing m·NA for the recording position of an optical disc relating to Example 8;

FIG. 24 is a form diagram for the lens in Example 5;

FIG. 25 is a form diagram for the lens in Example 4; and

FIG. 26 is a diagram showing schematically a light flux that passes through an objective lens and is converged on a recording position in an optical disc.

### DESCRIPTION OF THE PREFERRED EMBODIMENT

An optical pickup apparatus as a preferred embodiment of the present invention is an optical pickup apparatus for recording and/or reproducing information on an optical disc comprising at least one reference layer and at least one recording layer in which information can be recorded at a plurality of recording positions each of which is located at a different distance from a surface of the optical disc. The optical pickup apparatus includes: a light source; a relay lens system; an objective lens; a photodetector. The objective lens is arranged at a predetermined distance along an optical axis from the reference layer. The light source emits a light flux and the relay lens system for receiving the light flux emitted from the light source and emitting a converged light flux. The objective lens converges the converged light flux from the relay lens system onto one of the plurality of recording positions, and the photodetector receives a light flux emitted from the optical disc. The relay lens system changes a convergence angle of the converged light flux to enter the objective lens by moving in a direction of an optical axis thereof so as to select a recording position where information is recorded and/or reproduced.

In the embodiment, the objective lens is arranged at a prescribed position along the optical axis for the reference layer, namely, a distance between the objective lens and the reference layer is made to be constant independently of recording positions at different depth. The aforesaid relay lens system is displaced in the optical axis direction for selecting a recording position on which information is recorded and/or reproduced. Due to this, a convergence angle of the converged light flux entering the objective lens can be changed. Therefore, even when the recording position is changed and a substrate thickness is changed due to the change of the recording position, spherical aberration caused by change in the substrate thickness can be canceled. Thereby, information can be recorded and/or reproduced appropriately independently to a recording position. As the reference layer, it may either be a surface of an optical disc, or be a surface at the deepest position of an optical disc, or it may be an intermediate layer positioned in the optical disc. It is more preferable if the reference layer includes tracking information and servo information.

It is preferable that the aforesaid objective lens satisfies the following expression.

0.03<m·NA<0.55 (1)

In the expression, m represents a magnification of the objective lens, and NA represents a numerical aperture of the objective lens on the image side.

When m·NA is smaller than the upper limit of the expression (1), numerical aperture NA on the image side representing a side of entering the objective lens does not grow to be too large, and it is not necessary to construct a lens system having a high numerical aperture with a relay lens system. Therefore, constitution of the relay lens system becomes simple, or sufficient efficiencies can be satisfied, which is preferable. On the other hand, when m·NA is larger than the lower limit of expression (1), it is possible to sufficiently secure magnification m of the objective lens that is needed for changing an incident angle of a converged light flux that enters the objective lens, and spherical aberration caused by the difference between optical disc thicknesses can be corrected sufficiently, which is preferable. The objective lens more preferably satisfies the following expression (1′).

0.03<m·NA<0.47 (1′)

The objective lens further more preferably satisfies the following expression (1″).

0.05<m·NA<0.40 (1″)

It is preferable that the following expression is satisfied by the objective lens;

0.5<d/f<3.5 (2)

In the expression, d represents an axial thickness of the objective lens, and f represents a focal length of the objective lens.

When d/f is larger than the lower limit of expression (2), it is preferable because spherical aberration caused by a change in optical disc thickness can be corrected sufficiently. For example, if f grows greater compared to the value d, refractive power of the objective lens is lowered. Therefore, it is necessary to increase an entrance numerical aperture, namely, an incident angle of the objective lens, so that the numerical aperture of the objective lens on the image side may satisfies a numerical aperture prescribed by an optical disc. It means enlarging of magnification of the objective lens. In other words, it means that a numerical aperture of a relay lens system on the image side is enlarged. This problem does not affect to achieve the present invention, but it is preferable to be solved. When d/f is larger than the lower limit of the expression, the problem mentioned above can be avoided, and constitution of the relay lens system becomes simple, or sufficient optical efficiencies can be satisfied, which is preferable.

In contrast to this, when controlling enlargement of magnification m of the objective lens not to be excessively large, spherical aberration caused by the difference in thickness of the optical disc at the recording position cannot be corrected sufficiently by changing an incident angle of to the objective lens, although the requirement for the constitution of the relay lens system is made to be moderate.

Further, when d/f becomes small, a beam in the vicinity of a marginal beam that enters the objective lens needs to be refracted further greatly on an incident surface of the objective lens (that is, a surface of the objective lens opposite to the optical disc). It changes an amount of spherical aberration generated when an incident angle of light entering the objective lens changes, but the amount of spherical aberration is not changed greatly by causing d/f to be greater than the lower limit of expression (2). Therefore, the spherical aberration caused by a change in an optical disc thickness can be corrected appropriately.

On the other hand, when d/f is smaller than the upper limit of expression (2), refractive power for a beam in the vicinity of the marginal beam entering the objective lens does not become too weak. It does not greatly change the correction amount of the amount of spherical aberration generated when the incident angle to the objective lens changes, and spherical aberration caused by the change in an optical disc thickness at the recording position can be corrected appropriately. It is more preferable that the objective lens satisfies the following expression (2′).

0.8<d/f<1.7 (2′)

The embodiment of the present invention preferably satisfies Ns<Ni, where Ns is a number of reference layers, and Ni is a number of recording layers.

In the embodiment of the present invention, the optical disc preferably includes any one of 1 to 3 reference layers.

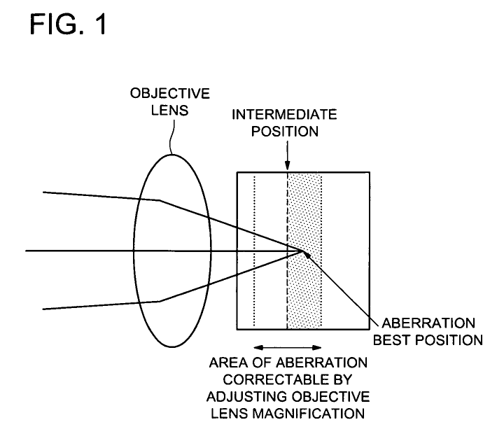

In the embodiment of the present invention, the recording layer of the optical disc preferably includes an aberration-correctable area extending in a direction of a thickness of the optical disc, in which an aberration caused due to a recording-layer thickness from a surface of the optical disc to a recording position is correctable. The objective lens preferably converges the converged light flux from the relay lens system with a minimum wavefront aberration at a position in the aberration-correctable area, where the position is located at a farther distance in a direction apart from the objective lens than a midpoint of a thickness of the aberration-correctable area, as shown in FIG. 1, in other words, the position is located at an opposite side of the light source across the midpoint of the thickness of the aberration-correctable area (see the shaded portion in FIG. 1).

In the present specifications, an objective lens means a lens having a converging function arranged at the position closest to an optical disc to face the optical disc, under the state wherein an optical disc is loaded in an optical pickup apparatus.

The invention makes it possible to provide an optical pickup apparatus capable of recording and/or reproducing information accurately for different plural recording positions in the optical axis direction, in the optical disc that can record information at recording positions each being different in terms of a distance from the surface.

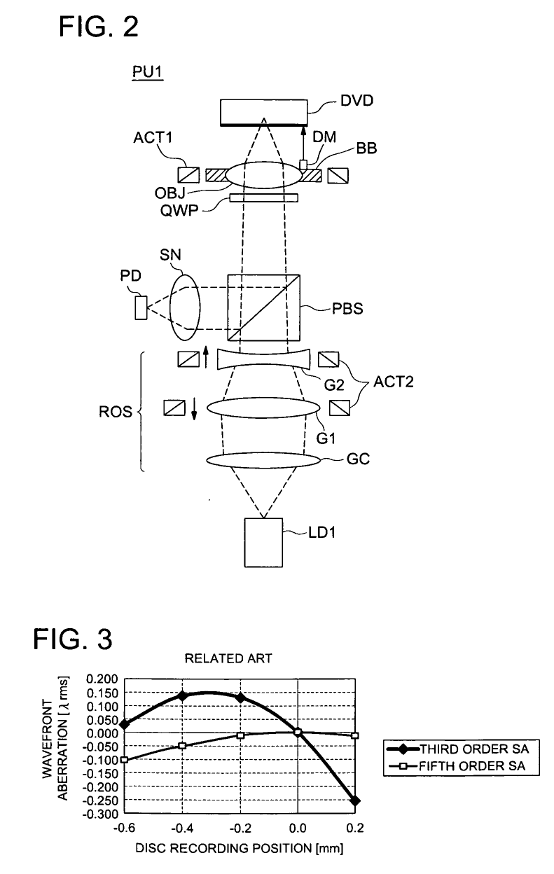

An embodiment of the invention will be explained as follows, referring to the drawings. Incidentally, optical pickup apparatus PU1 relating to the present embodiment can record and/or reproduce information on the multi-layer DVD as an optical disc capable of recording information, at recording positions in a recording layer each located at different distance from the disc surface, for example. The optical pickup apparatus can be incorporated in an optical disc apparatus. FIG. 2 is a diagram showing a schematic constitution of optical pickup apparatus PU1. In the specification, optical discs can be called generically as OD.

In the present embodiment, optical distance meter DM is arranged on bobbin BB that holds objective lens OBJ so that a distance up to the surface of multi-layer DVD (which represents a reference layer) may be measured. The bobbin BB is driven by the first actuator ACT1, together with objective lens OBJ, in the tracking direction and in the focus direction. Here, a distance between the objective lens OBJ and the surface of the multi-layer DVD is always maintained to be constant based on signals of the distance meter DM.

Relay lens system ROS has therein collimator lens GC, first lens group G1 having positive refractive power and second lens group G2 having negative refractive power, in this order from the semiconductor laser LD1 side. In this case, it is defined that the second lens group G2 is displaced by second actuator ACT2 in the optical axis direction.

When recording/reproducing information on the first recording position that is located away from the disc surface by the first distance in DVD, the second lens group G2 of relay lens system ROS is displaced to the predetermined position along the optical axis by the second actuator ACT2, and semiconductor laser LD1 is caused to emit light. A divergent light flux is emitted from the semiconductor laser LD1 and enters collimator lens GC to be converted into a parallel light flux. Then, it passes through the first lens group G1 to be converted into a convergent light flux, and passes through the second lens group G2 to be converted into a convergent light flux having a convergent angle of θ1. The convergent light flux passes through polarized beam splitter PBS and λ/4 wavelength plate QWP and enters objective lens OBJ under the converged state, to become a spot formed at the first recording position that is away from a surface of DVD by a predetermined distance.

The light flux is reflected on DVD and passes again through objective lens OBJ and λ/4 wavelength plate QWP, to be reflected on the polarized beam splitter PBS. The light flux enters photodetector PD through sensor lens SN. Information recorded on the first recording position of DVD can be read by signals outputted from the photodetector PD.

Next, when recording/reproducing information on the second recording position that is away from a DVD surface by the second distance that is shallower (alternatively, deeper) than the first distance in DVD, the second lens group G2 of relay lens system ROS is displaced to the side to be closer to (alternatively, farther from) objective lens OBJ by the second actuator ACT2, and semiconductor laser LD1 is caused to emit light. A divergent light flux emitted from the semiconductor laser LD1 enters collimator lens GC to be converted into a parallel light flux. The parallel light flux passes through the first lens group G1 to be converted into a convergent light flux, then, it passes through the second lens group G2 to be converted into a convergent light flux having a convergent angle of θ2 (≠θ1). The convergent light flux passes through polarized beam splitter PBS and λ/4 wavelength plate QWP and enters objective lens OBJ, to become a spot formed at the second recording position that is away from a surface of DVD by the second distance.

The light flux is reflected on DVD and passes again through objective lens OBJ and λ/4 wavelength plate QWP, to be reflected on the polarized beam splitter PBS, and enters photo-detector PD through sensor lens SN. Information recorded on the second recording position of DVD can be read by signals outputted from the photodetector PD.

In the present embodiment, when recording/reproducing information on the second recording position that is shallower (alternatively, deeper) than a prescribed distance from a surface of DVD, under the condition that the first lens group G1 is driven by the second actuator ACT2, the first lens group G1 may be displaced to the side that is farther from (alternatively, closer to) the objective lens OBJ than a predetermined position on the optical axis.

In the present embodiment, objective lens OBJ is arranged at a predetermined distance along the optical axis from the reference layer (a disc surface). On the other hand, when selecting a recording position for recording and/or reproducing information, relay lens system ROS is displaced along the optical axis. Owing to this, a divergent angle or a convergent angle of a light flux entering objective lens OBJ can be changed, thus, even when the recording position in the recording layer is changed and a thickness of a protective substrate is changed accordingly, spherical aberration caused by the change of the thickness can be canceled, and information can be appropriately recorded and/reproduced independently to a recording position.

### EXAMPLE

Next, an example of an objective lens that can be used for the present embodiment will be explained as follows, while comparing with comparative examples. In the following description including lens data in tables, an exponent of 10 is expressed by using E. For example, 2.5E-3 represents 2.5×10⁻³.

Some optical surfaces of the optical system relating to a comparative example and to an example are formed to be an aspheric surface that is axisymmetric around the optical axis and is prescribed by a numerical expression in which a coefficient shown in the table is substituted in the following expression (3).

$$Z ( h ) = \frac{{h}^{2} / r}{1 + \sqrt{1 - ( 1 + k ) {( h / r )}^{2}}} + {\sum }_{i = 2} {A}_{2 i} {h}^{2 i} \qquad ( 3 )$$

In the expression, Z(h) represents an aspheric surface form represented by a distance from a surface vertex of the aspheric surface in the direction parallel to an optical axis, where light advancing direction is assumed to be positive; h represents a height in the direction perpendicular to the optical axis; r represents a radius of curvature; and k represents a conic constant and each of A₄, A₆, . . . A₂₀ represents an aspheric surface coefficient.

### Comparative Example 1

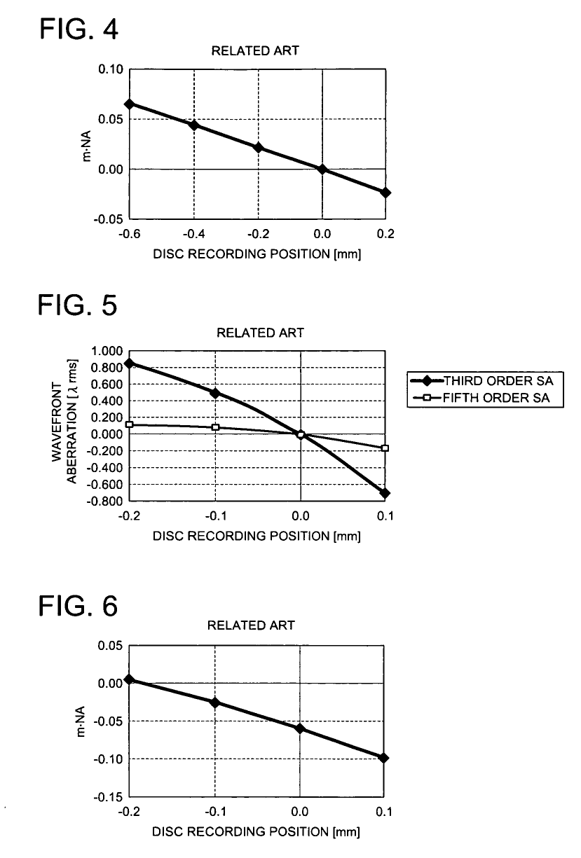

Table 1 shows lens data of Comparative Example 1. In the Comparative Example 1, the optical pickup apparatus is designed such that an optical disc thickness becomes 0.6 mm when a recording position in the optical disc is 0.0 mm, and that collimated light (infinite light) enters an objective lens when a recording position of the optical disc is 0.0 mm. Each of FIGS. 3 and 4 shows how aberrations are corrected when an error in the optical disc thickness is corrected by changing a convergent angle of convergent light flux entering an objective lens (in other words, by adjusting a magnification) in the optical pickup apparatus in Comparative Example 1. FIG. 3 shows a graph indicating an amount of spherical aberration for the recording position of the optical disc relating to Comparative Example 1, and FIG. 4 shows a graph indicating m·NA for the recording position of the optical disc relating to Comparative Example 1. In this case, a working distance of the objective lens in the case of magnification adjusting is caused to be constant. When a value of the recording position of the optical disc becomes small, the recording position comes to be close to a surface of an optical disc. As shown in FIG. 4, when the recording position of the optical disc is 0 mm, an infinite light flux enters the objective lens because magnification m of an incident light flux is zero. When the recording position of the optical disc is smaller than 0 mm, magnification m is larger than zero, namely, a convergent light enters the objective lens. When the recording position of an optical disc is larger than 0 mm, magnification m is smaller than zero, namely, a divergent light enter the objective lens. As shown in FIG. 3, when the objective lens where an infinite light enters is used, it is understood that wavefront aberration is not corrected properly by adjusting the magnification.

TABLE 1
Comparative Example 1
Basic lens data

| Surface | Radius of | Surface | ni | |
|---|---|---|---|---|
| No. | curvature | clearance | (λ = 660 nm) | Remarks |
| 1 | ∞ | ∞ | | Light source |
| 2 (STO) | ∞ | 0.00000 | | Aperture |
| | | | | (diameter: |
| | | | | 5.359 mm) |
| 3 | 2.79183 | 4.50000 | 1.58581 | |
| 4 | −5.89981 | 1.23849 | | |
| 5 | ∞ | 0.60000 | 1.57962 | |
| 6 | ∞ | | | |

Aspheric surface coefficient

| Surface | | |
|---|---|---|
| No. | 2^{nd} surface | 3^{rd} surface |
| k | −7.99759E−01 | −4.53772E+01 |
| A4 | 1.97694E−03 | 7.51556E−03 |
| A6 | 6.87591E−05 | −2.98987E−03 |
| A8 | −2.03607E−07 | 6.23496E−04 |
| A10 | 7.62521E−07 | −6.39840E−05 |
| A12 | −1.52494E−07 | 1.59236E−06 |
| A14 | 1.15471E−08 | 6.97496E−09 |
| A16 | −4.97169E−10 | 4.61267E−13 |
| A18 | 0.00000E+00 | 0.00000E+00 |
| A20 | 0.00000E+00 | 0.00000E+00 |

| | |
|---|---|
| m | 0.00 |
| m · NA | 0.00 |
| d | 4.50 |
| f | 4.00 |
| d/f | 1.13 |

m: Working magnification of objective lens at the optical
disc thickness of 0.6 mm
d: an axial thickness of the objective lens

### Comparative Example 2

Table 2 shows lens data of Comparative Example 2. In the Comparative Example 2, the optical pickup is designed such that an optical disc thickness becomes 0.6 mm when a recording position of an optical disc is 0.0 mm, and divergent light enters the objective lens when the recording position of the optical disc is 0.0 mm. Each of FIGS. 5 and 6 shows how aberrations are corrected when an error in the optical disc thickness is corrected by changing a convergent angle of convergent light flux entering the objective lens (namely, by adjusting the magnification) in the optical pickup apparatus in Comparative Example 2. FIG. 5 shows a graph indicating an amount of spherical aberration for the recording position of the optical disc relating to Comparative Example 2, and FIG. 6 shows a graph indicating m·NA for recording position of an optical disc relating to Comparative Example 2. It is understood from FIG. 5 that correction is not carried out properly even when a magnification is corrected, by using the objective lens where divergent light enters.

TABLE 2
Comparative Example 2
Basic lens data

| Surface | Radius of | Surface | ni | |
|---|---|---|---|---|
| No. | curvature | clearance | (λ = 658 nm) | Remarks |
| 1 | ∞ | 20.00000 | | Light source |
| 2 (STO) | ∞ | 0.00000 | | Aperture |
| | | | | (diameter: |
| | | | | 2.000 mm) |
| 3 | 0.95549 | 1.60000 | 1.58588 | |
| 4 | −69.00221 | 0.38195 | | |
| 5 | ∞ | 0.60000 | 1.57975 | |
| 6 | ∞ | | | |

Aspheric surface coefficient

| Surface | | |
|---|---|---|
| No. | 2^{nd} surface | 3^{rd} surface |
| k | −8.73947E−01 | 9.34561E+02 |
| A4 | 6.10599E−02 | 3.26516E−01 |
| A6 | 2.22563E−02 | −6.47849E−01 |
| A8 | 1.02861E−02 | 5.40422E−01 |
| A10 | 2.05138E−04 | −1.46107E−01 |
| A12 | 3.35517E−03 | 0.00000E+00 |
| A14 | 0.00000E+00 | 0.00000E+00 |
| A16 | 0.00000E+00 | 0.00000E+00 |
| A18 | 0.00000E+00 | 0.00000E+00 |
| A20 | 0.00000E+00 | 0.00000E+00 |

| | |
|---|---|
| m | −0.09 |
| m · NA | −0.06 |
| d | 1.60 |
| f | 1.62 |
| d/f | 0.99 |

m: Working magnification of objective lens at the optical
disc thickness of 0.6 mm
d: an axial thickness of the objective lens

### Example 1

Table 3 shows lens data of Example 1. In the Example 1, the optical pickup apparatus is designed such that an optical disc thickness becomes 0.6 mm when a recording position of an optical disc is 0.0 mm, and convergent light enters the objective lens when the recording position of the optical disc is 0.0 mm. FIG. 8 shows a graph indicating an amount of spherical aberration for the recording position of the optical disc relating to Example 1, and FIG. 9 shows a graph indicating m·NA for the recording position of the optical disc relating to Example 1. As is apparent from FIG. 8, neither 3^{rd} order spherical aberration nor 5^{th} order spherical aberration is increased even when the recording position is changed in the direction of a depth. Therefore, generation of spherical aberration caused by the recording position of the optical disc is reduced by adjusting the magnification. Incidentally, in the case of optical disc recording position=0.0 mm, m·NA is 0.18 and d/f is 0.89 respectively for values of expressions (1) and (2).

TABLE 3
Example 1
Basic lens data

| Surface | Radius of | Surface | ni | |
|---|---|---|---|---|
| No. | curvature | clearance | (λ = 660 nm) | Remarks |
| 1 | ∞ | −9.32017 | | Light source |
| 2 (STO) | ∞ | 0.00000 | | Aperture |
| | | | | (diameter: |
| | | | | 5.332 mm) |
| 3 | 5.96928 | 4.43651 | 1.58581 | |
| 4 | −4.17200 | 1.22414 | | |
| 5 | ∞ | 0.60000 | 1.57962 | |
| 6 | ∞ | | | |

Aspheric surface coefficient

| Surface | | |
|---|---|---|
| No. | 2^{nd} surface | 3^{rd} surface |
| k | −4.67824E−01 | −8.33548E+00 |
| A4 | −1.50161E−03 | −7.72758E−03 |
| A6 | −1.32756E−04 | 6.80978E−04 |
| A8 | −1.57257E−05 | −1.76072E−04 |
| A10 | 8.23857E−07 | 7.53222E−05 |
| A12 | −1.07809E−07 | −1.75133E−05 |
| A14 | −2.96789E−08 | 6.59810E−07 |
| A16 | 3.23288E−09 | 2.01729E−07 |
| A18 | 2.26375E−10 | 3.73587E−08 |
| A20 | −4.22702E−11 | −9.99038E−09 |

| | |
|---|---|
| m | 0.28 |
| m · NA | 0.18 |
| d | 4.44 |
| f | 5.00 |
| d/f | 0.89 |

m: Working magnification of objective lens at the optical
disc thickness of 0.6 mm
d: an axial thickness of the objective lens

In Example 1, when a disc thickness is 0.6 mm, for example, a distance between an object point of the objective lens and the objective lens is −9.320 mm. In this case, the object point of the objective lens shows an image point that is formed when a light flux emitted from the light source is converged by the relay lens system. Now, when a protective substrate thickness of the optical disc is increased by 0.6 mm to be 1.2 mm, a distance between an object point of the objective lens and the objective lens can be made to be −12.175 mm, when correcting the generated aberration by adjusting the magnification. In this case, defocus among aberration components is 0 mλrms, and SA among aberration components is 1 mλrms. In the same way, when the protective substrate thickness of the optical disc is made to be 0.0 mm by reducing by 0.6 mm, a distance between an object point of the objective lens and the objective lens is −7.367 mm, and in this case, defocus is 0 mλrms, and SA is 1 mλrms. It is understood that aberration generated by a protective substrate thickness of an optical disc is corrected by adjusting the magnification as stated above. Especially, in this case, it is possible to correct without changing a working distance which is a distance between the objective lens and the optical disc.

### Example 2

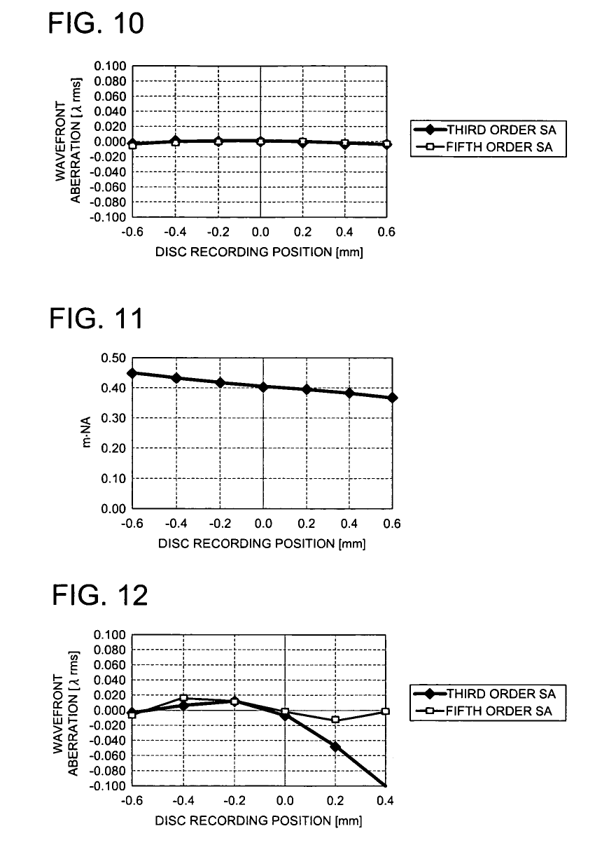

Table 4 shows lens data of Example 2. In the Example 2, the optical pickup apparatus is designed such that an optical disc thickness becomes 0.6 mm when a recording position of an optical disc is 0.0 mm, and convergent light enters an objective lens when the recording position of an optical disc is 0.0 mm. FIG. 10 shows a graph indicating an amount of spherical aberration for the recording position of the optical disc relating to Example 2, and FIG. 11 shows a graph indicating m·NA for the recording position of the optical disc relating to Example 2. As is apparent from FIG. 10, neither 3^{rd} order spherical aberration nor 5^{th} order spherical aberration is increased even when the recording position is changed in the direction of a depth, and therefore, generation of spherical aberration caused by the recording position of the optical disc is reduced by adjusting the magnification. Incidentally, in the case of optical disc recording position=0.0 mm, m·NA is 0.41 and d/f is 0.69 respectively for values of expressions (1) and (2). Especially, in this case, it is possible to correct without changing a working distance which is a distance between an objective lens and an optical disc.

TABLE 4
Example 2
Basic lens data

| Surface | Radius of | Surface | ni | |
|---|---|---|---|---|
| No. | curvature | clearance | (λ = 660 nm) | Remarks |
| 1 | ∞ | −5.95469 | | Light source |
| 2 (STO) | ∞ | 0.00000 | | Aperture |
| | | | | (diameter: |
| | | | | 5.332 mm) |
| 3 | 7.39647 | 4.50000 | 1.58581 | |
| 4 | −6.08409 | 0.70283 | | |
| 5 | ∞ | 0.60000 | 1.57962 | |
| 6 | ∞ | | | |

Aspheric surface coefficient

| Surface | | |
|---|---|---|
| No. | 2^{nd} surface | 3^{rd} surface |
| k | −9.17254E−01 | −4.86784E−01 |
| A4 | −5.74552E−04 | 5.45221E−03 |
| A6 | −4.27252E−05 | −3.93551E−03 |
| A8 | −5.72452E−06 | 1.69130E−03 |
| A10 | 7.31754E−07 | −3.17338E−04 |
| A12 | −1.52744E−07 | −1.95018E−07 |
| A14 | 1.75780E−08 | −3.06943E−15 |
| A16 | −1.56927E−09 | 0.00000E+00 |
| A18 | 6.97484E−11 | 0.00000E+00 |
| A20 | 0.00000E+00 | 0.00000E+00 |

| | |
|---|---|
| m | 0.61 |
| m · NA | 0.41 |
| d | 4.50 |
| f | 6.50 |
| d/f | 0.69 |

m: Working magnification of objective lens at the optical
disc thickness of 0.6 mm
d: an axial thickness of the objective lens

In this case, d/f in Example 2 is smaller than that in Example 1. This shows that refractive power of the objective lens is weak because f is great. However, it is understood that the numerical aperture of the objective lens on the entering side, namely, the magnification is made to be greater to satisfy the expressions (1) and (2) because a numerical aperture entering an optical disc is determined to be a prescribed value. In Example 2, m·NA is within a range of expression (1), and it is close to the upper limit. When the upper limit of the expression (1) is not exceeded, constitution of the lens system is not complicated, which is preferable.

### Example 3

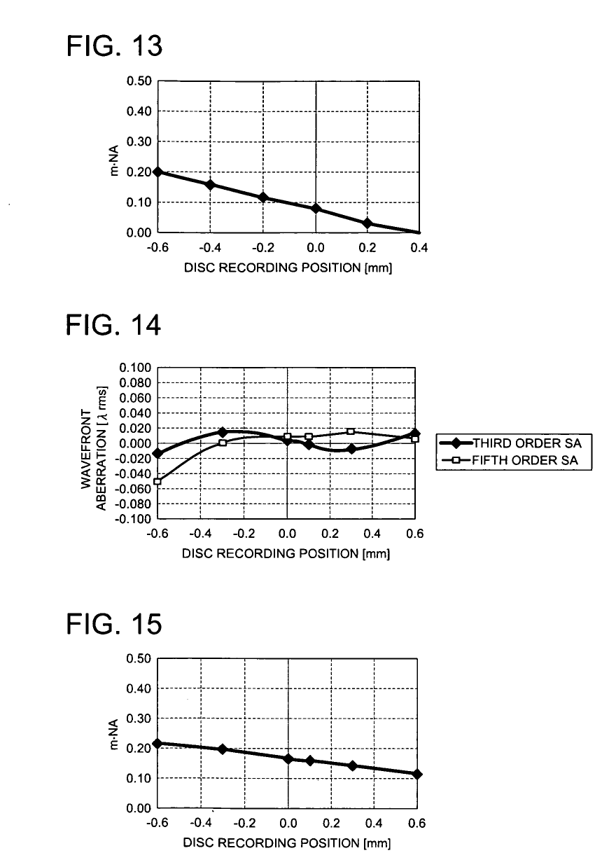

Table 5 shows lens data of Example 3. In the Example 3, the optical pickup apparatus is designed such that an optical disc thickness becomes 0.6 mm when a recording position of the optical disc is 0.0 mm, and convergent light enters the objective lens when the recording position of the optical disc is 0.0 mm. FIG. 12 shows a graph indicating an amount of spherical aberration for the recording position of the optical disc relating to Example 3, and FIG. 13 shows a graph indicating m·NA for the recording position of the optical disc relating to Example 3. As is apparent from FIG. 12, generation of spherical aberration caused by the recording position of the optical disc is reduced by adjusting the magnification. Incidentally, in the case of optical disc recording position=0.0 mm, m·NA is 0.08 and d/f is 1.23 respectively for values of expressions (1) and (2). In Example 3, m·NA is within a range of expression (1), and it is close to the lower limit. When the lower limit of expression (1) is exceeded, spherical aberration can be corrected sufficiently by a change of the optical disc thickness.

TABLE 5
Example 3
Basic lens data

| Surface | Radius of | Surface | ni | |
|---|---|---|---|---|
| No. | curvature | clearance | (λ = 660 nm) | Remarks |
| 1 | ∞ | −16.76825 | | Light source |
| 2 (STO) | ∞ | 0.00000 | | Aperture |
| | | | | (diameter: |
| | | | | 2.661 mm) |
| 3 | 2.19816 | 2.46231 | 1.58581 | |
| 4 | −1.47070 | 0.56597 | | |
| 5 | ∞ | 0.60000 | 1.57962 | |
| 6 | ∞ | | | |

Aspheric surface coefficient

| Surface | | |
|---|---|---|
| No. | 2^{nd} surface | 3^{rd} surface |
| k | −1.19057E+00 | −8.66658E+00 |
| A4 | −1.20487E−03 | −7.34835E−02 |
| A6 | −8.40674E−04 | 1.91137E−02 |
| A8 | −7.04655E−03 | −6.01908E−04 |
| A10 | 2.50440E−03 | −3.76318E−03 |
| A12 | −9.01119E−04 | 1.14665E−03 |
| A14 | 1.54227E−04 | 2.79011E−04 |
| A16 | −1.34424E−04 | −4.07982E−05 |
| A18 | −3.81043E−06 | −4.73547E−05 |
| A20 | 0.00000E+00 | 0.00000E+00 |

| | |
|---|---|
| m | 0.11 |
| m · NA | 0.08 |
| d | 2.46 |
| f | 2.00 |
| d/f | 1.23 |

m: Working magnification of objective lens at the optical
disc thickness of 0.6 mm
d: an axial thickness of the objective lens

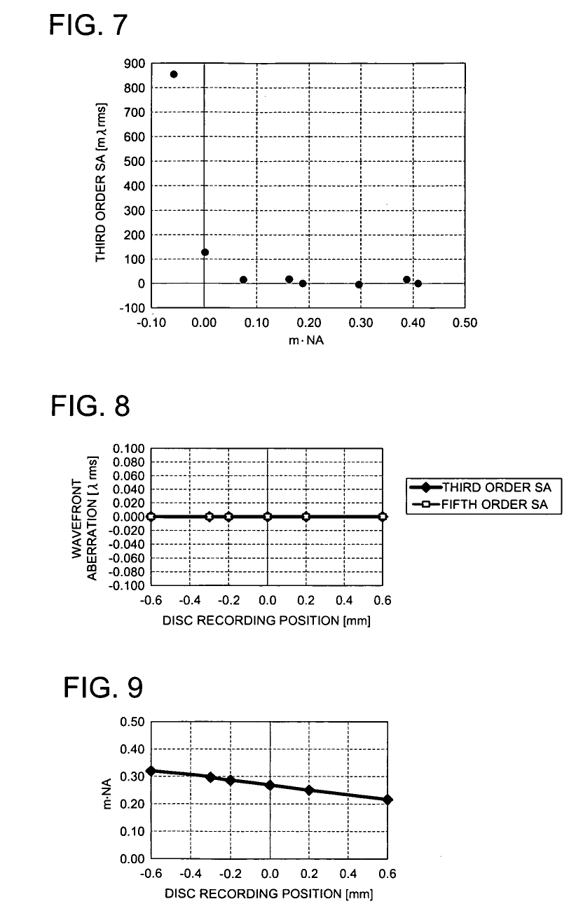

FIG. 7 is a diagram wherein m·NA in the case of disc thickness error of 0.0 mm and third order spherical aberration in the case of disc thickness error of −0.2 mm are plotted, as an example. When the lower limit of expression (1) is exceeded by m·NA as mentioned above, it is understood that spherical aberration caused by a difference of a disc thickness can be corrected sufficiently even when a disc thickness error is −0.2 mm.

### Example 4

Table 6 shows lens data of Example 4. In the Example 4, the optical pickup apparatus is designed such that an optical disc thickness becomes 0.6 mm when a recording position of the optical disc is 0.0 mm, and convergent light enters an objective lens when the recording position of the optical disc is 0.0 mm. FIG. 14 shows a graph indicating an amount of spherical aberration for the recording position of the optical disc relating to Example 4, and FIG. 15 shows a graph indicating m·NA for a recording position of the optical disc relating to Example 4. As is apparent from FIG. 14, generation of spherical aberration caused by the recording position the optical disc is reduced by adjusting the magnification. Incidentally, in the case of the optical disc recording position=0.0 mm, m·NA is 0.16 and d/f is 1.02 respectively for values of expressions (1) and (2).

TABLE 6
Example 4
Basic lens data

| Surface | Radius of | Surface | ni | |
|---|---|---|---|---|
| No. | curvature | clearance | (λ = 660 nm) | Remarks |
| 1 | ∞ | −15.75630 | | Light source |
| 2 (STO) | ∞ | 0.00000 | | Aperture |
| | | | | (diameter: |
| | | | | 5.332 mm) |
| 3 | 3.00000 | 5.09502 | 1.58581 | |
| 4 | −46.13998 | 0.26596 | | |
| 5 | ∞ | 0.60000 | 1.57962 | |
| 6 | ∞ | | | |

Aspheric surface coefficient

| Surface | | |
|---|---|---|
| No. | 2^{nd} surface | 3^{rd} surface |
| k | 1.77209E−02 | −1.40490E+02 |
| A4 | −7.13146E−04 | 2.57244E−01 |
| A6 | −7.08167E−06 | −6.15035E−01 |
| A8 | −2.66609E−05 | 1.08877E+00 |
| A10 | −1.21454E−06 | −7.32663E−01 |
| A12 | 6.72349E−07 | −4.55180E−06 |
| A14 | −8.21451E−08 | 1.13738E−14 |
| A16 | −1.49979E−09 | 0.00000E+00 |
| A18 | 0.00000E+00 | 0.00000E+00 |
| A20 | 0.00000E+00 | 0.00000E+00 |

| | |
|---|---|
| m | 0.24 |
| m · NA | 0.16 |
| d | 5.12 |
| f | 5.00 |
| d/f | 1.02 |

m: Working magnification of objective lens at the optical
disc thickness of 0.6 mm
d: an axial thickness of the objective lens

### Example 5

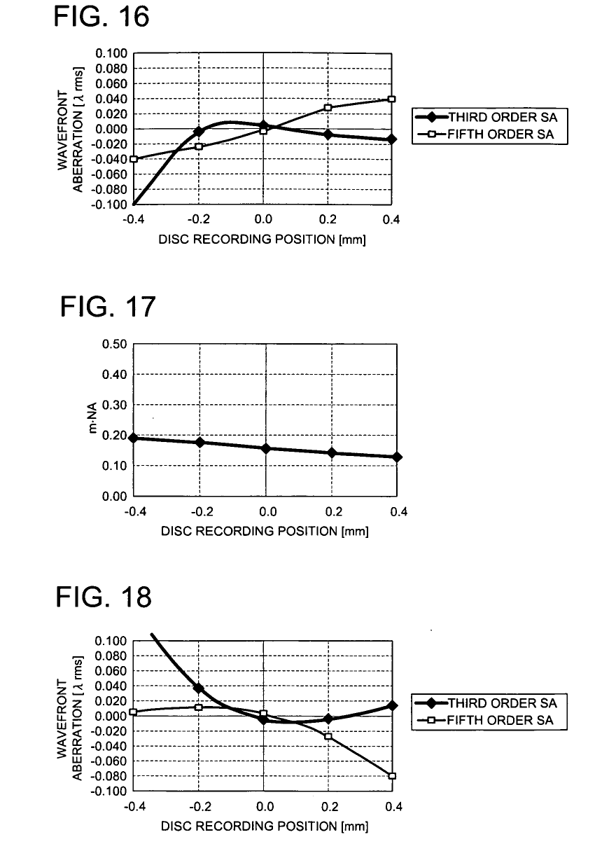

Table 7 shows lens data of Example 5. In the Example 5, the optical pickup apparatus is designed such that an optical disc thickness becomes 0.6 mm when a recording position of the optical disc is 0.0 mm, and convergent light enters the objective lens when the recording position of the optical disc is 0.0 mm. FIG. 16 shows a graph indicating an amount of spherical aberration for the recording position of the optical disc relating to Example 5, and FIG. 17 shows a graph indicating m·NA for the recording position of the optical disc relating to Example 5. As is apparent from FIG. 16, generation of spherical aberration caused by the recording position of the optical disc is reduced by adjusting the magnification, as far as the optical disc recording position is from −0.2 mm to +0.4 mm. Incidentally, m·NA is 0.16 and d/f is 0.63 respectively for values of expressions (1) and (2) in the case of optical disc recording position=0.0 mm.

TABLE 7
Example 5
Basic lens data

| Surface | Radius of | Surface | ni | |
|---|---|---|---|---|
| No. | curvature | clearance | (λ = 660 nm) | Remarks |
| 1 | ∞ | −16.00042 | | Light source |
| 2 (STO) | ∞ | 0.00000 | | Aperture |
| | | | | (diameter: |
| | | | | 5.332 mm) |
| 3 | 2.37297 | 3.90000 | 1.58581 | |
| 4 | 2.68568 | 0.55058 | | |
| 5 | ∞ | 0.60000 | 1.57962 | |
| 6 | ∞ | | | |

Aspheric surface coefficient

| Surface | | |
|---|---|---|
| No. | 2^{nd} surface | 3^{rd} surface |
| k | −1.33381E−01 | −6.12379E+01 |
| A4 | −7.43713E−04 | 3.12406E−01 |
| A6 | 2.70303E−04 | 7.93885E−02 |
| A8 | −6.33991E−05 | −9.40693E−01 |
| A10 | 4.91482E−06 | 1.53059E+00 |
| A12 | 9.00606E−07 | 0.00000E+00 |
| A14 | −1.74897E−07 | 0.00000E+00 |
| A16 | −2.66045E−08 | 0.00000E+00 |
| A18 | 5.39139E−09 | 0.00000E+00 |
| A20 | 0.00000E+00 | 0.00000E+00 |

| | |
|---|---|
| m | 0.24 |
| m · NA | 0.16 |
| d | 3.90 |
| f | 6.20 |
| d/f | 0.63 |

m: Working magnification of objective lens at the optical
disc thickness of 0.6 mm
d: an axial thickness of the objective lens

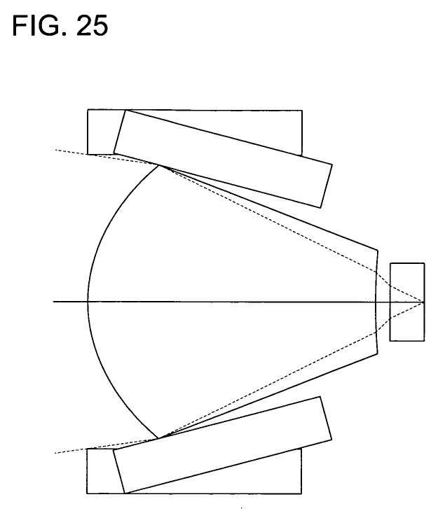

In Example 5, d/f is within a range of expression (2), and it is an example that is close to the lower limit. As explained in the specifications, when d/f exceeds the lower limit of expression (2), spherical aberration caused by a difference of an optical disc thickness can be corrected sufficiently, which is preferable. When comparing with Example 4, it is understood that d/f is smaller, and a degree of correction of spherical aberration caused by a difference of a disc thickness is changed as shown in FIG. 16. Further, power at an incident surface for a light flux of the lens has grown greater because d/f has been made smaller. A diagram of a shape of the lens in Example 5 is shown in FIG. 24. In addition, a diagram of a shape of the lens in Example 4 is shown in FIG. 25. As shown in the drawing, the power at an incident surface for a light flux of the lens in Example 5 is greater than that in Example 4. Due to this, an amount of spherical aberration caused by changes in magnification, namely, changes in incident angle to the objective lens, is changed.

### Example 6

Table 8 shows lens data of Example 6. In the Example 6, the optical pickup apparatus is designed such that an optical disc thickness becomes 0.6 mm when a recording position of the optical disc is 0.0 mm, and convergent light enters an objective lens when the recording position of the optical disc is 0.0 mm. FIG. 18 shows a graph indicating an amount of spherical aberration for the recording position of the optical disc relating to Example 6, and FIG. 19 shows a graph indicating m·NA for the recording position of the optical disc relating to Example 6. As is apparent from FIG. 18, generation of spherical aberration caused by the recording position of the optical disc is reduced by adjusting the magnification, as far as the optical disc recording position is from −0.2 mm to +0.4 mm. Incidentally, m·NA is 0.16 and d/f is 0.61 respectively for values of expressions (1) and (2) in the case of optical disc recording position=0.0 mm.

TABLE 8
Example 6
Basic lens data

| Surface | Radius of | Surface | ni | |
|---|---|---|---|---|
| No. | curvature | clearance | (λ = 660 nm) | Remarks |
| 1 | ∞ | −15.73409 | | Light source |
| 2 (STO) | ∞ | 0.00000 | | Aperture |
| | | | | (diameter: |
| | | | | 5.332 mm) |
| 3 | 4.36455 | 6.10000 | 1.60537 | |
| 4 | −2.19754 | 0.53459 | | |
| 5 | ∞ | 0.60000 | 1.62230 | |
| 6 | ∞ | | | |

Aspheric surface coefficient

| Surface | | |
|---|---|---|
| No. | 2^{nd} surface | 3^{rd} surface |
| k | 2.77598E−02 | −1.64615E+01 |
| A4 | −6.08055E−04 | −1.53691E−02 |
| A6 | −4.61217E−05 | 4.27875E−03 |
| A8 | −9.40704E−06 | −1.28912E−03 |
| A10 | 7.30997E−07 | 3.04037E−04 |
| A12 | −9.57689E−08 | 0.00000E+00 |
| A14 | −1.15662E−09 | 0.00000E+00 |
| A16 | 6.76840E−13 | 0.00000E+00 |
| A18 | 0.00000E+00 | 0.00000E+00 |
| A20 | 0.00000E+00 | 0.00000E+00 |

| | |
|---|---|
| m | 0.24 |
| m · NA | 0.16 |
| d | 6.10 |
| f | 3.80 |
| d/f | 1.61 |

m: Working magnification of objective lens at the optical
disc thickness of 0.6 mm
d: an axial thickness of the objective lens

### Example 7

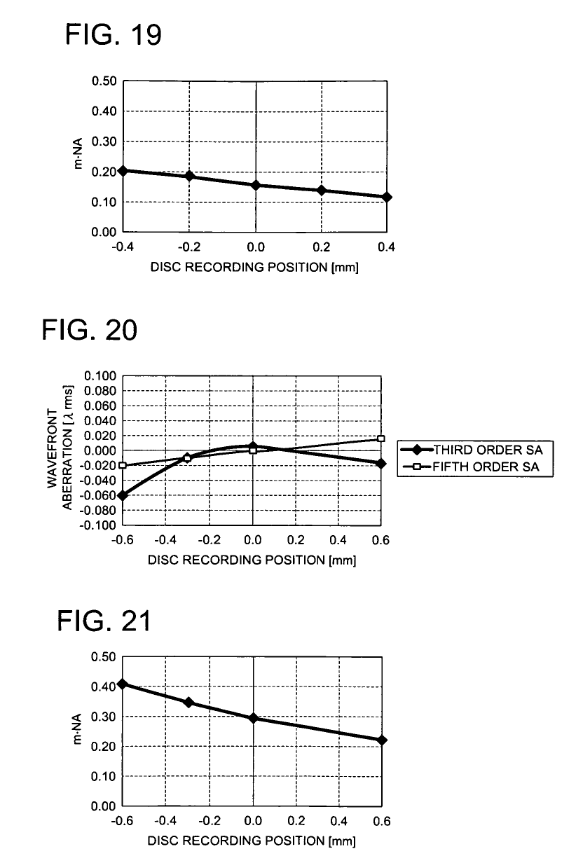

Table 9 shows lens data of Example 7. In the Example 7, the optical pickup apparatus is designed such that an optical disc thickness becomes 0.6 mm when a recording position of an optical disc is 0.0 mm, and convergent light enters the objective lens when the recording position of the optical disc is 0.0 mm. FIG. 20 shows a graph indicating an amount of spherical aberration for the recording position of the optical disc relating to Example 7, and FIG. 21 shows a graph indicating m·NA for the recording position of the optical disc relating to Example 7. As is apparent from FIG. 20, generation of spherical aberration caused by the recording position of the optical disc is reduced by adjusting the magnification, as far as the optical disc recording position is from −0.6 mm to +0.6 mm. Incidentally, m·NA is 0.29 and d/f is 3.33 respectively for values of expressions (1) and (2) in the case of optical disc recording position=0.0 mm.

TABLE 9
Example 7
Basic lens data

| Surface | Radius of | Surface | ni | |
|---|---|---|---|---|
| No. | curvature | clearance | (λ = 660 nm) | Remarks |
| 1 | ∞ | −5.89116 | | Light source |
| 2 (STO) | ∞ | 0.00000 | | Aperture |
| | | | | (diameter: |
| | | | | 5.332 mm) |
| 3 | 5.52712 | 5.00000 | 1.60537 | |
| 4 | −0.69567 | 0.09415 | | |
| 5 | ∞ | 0.60000 | 1.62230 | |
| 6 | ∞ | | | |

Aspheric surface coefficient

| Surface | | |
|---|---|---|
| No. | 2^{nd} surface | 3^{rd} surface |
| k | 8.62658E−01 | −9.90628E+17 |
| A4 | −7.29919E−04 | −1.12431E−01 |
| A6 | −6.01063E−05 | 5.42462E−01 |
| A8 | 1.07911E−05 | −1.41711E+00 |
| A10 | −2.52082E−06 | 1.42523E+00 |
| A12 | −5.79167E−08 | 1.95309E−04 |
| A14 | 6.94742E−08 | 6.59665E−07 |
| A16 | 6.04360E−13 | 2.01724E−07 |
| A18 | −1.88262E−09 | 3.73593E−08 |
| A20 | 1.55639E−10 | −9.98997E−09 |

| | |
|---|---|
| m | 0.44 |
| m · NA | 0.29 |
| d | 5.00 |
| f | 1.50 |
| d/f | 3.33 |

m: Working magnification of objective lens at the optical
disc thickness of 0.6 mm
d: an axial thickness of the objective lens

In Example 7, d/f is within a range of expression (2), and it is an example that is close to the upper limit. As explained in the specifications, when d/f is lower than the upper limit of expression (2), spherical aberration caused by a difference of an optical disc thickness can be corrected sufficiently, which is preferable.

### Example 8

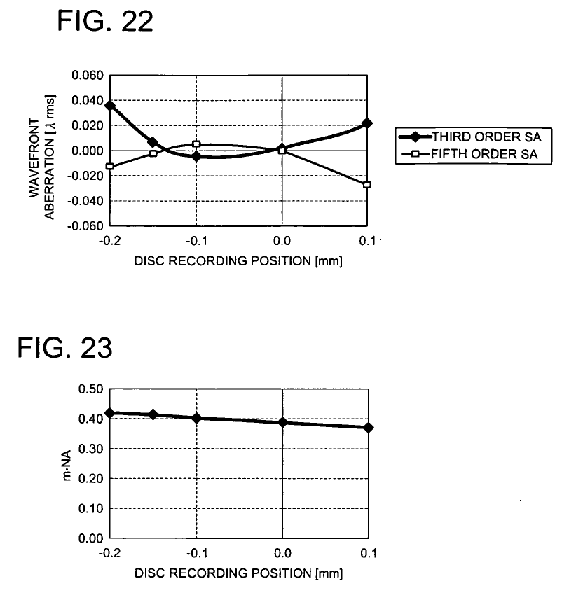

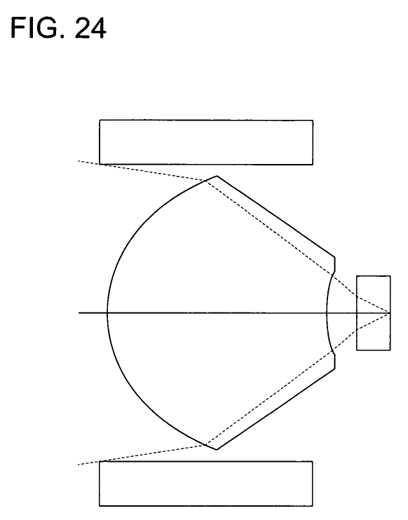

Table 10 shows lens data of Example 8. In the Example 8, the optical pickup apparatus is designed such that the optical disc thickness becomes 0.6 mm when a recording position of the optical disc is 0.0 mm, and convergent light enters an objective lens when the recording position of the optical disc is 0.0 mm. FIG. 22 shows a graph indicating an amount of spherical aberration for the recording position of an optical disc relating to Example 8, and FIG. 23 shows a graph indicating m·NA for the recording position of the optical disc relating to Example 7. As is apparent from FIG. 22, generation of spherical aberration caused by the recording position of the optical disc is reduced by adjusting the magnification. Incidentally, m·NA is 0.39 and d/f is 1.54 respectively for values of expressions (1) and (2) in the case of optical disc recording position=0.0 mm.

TABLE 10
Example 8
Basic lens data

| Surface | Radius of | Surface | ni | |
|---|---|---|---|---|
| No. | curvature | clearance | (λ = 405 nm) | Remarks |
| 1 | ∞ | −6.37823 | | Light source |
| 2 (STO) | ∞ | 0.00000 | | Aperture |
| | | | | (diameter: |
| | | | | 5.500 mm) |
| 3 | 3.97642 | 4.61661 | 1.60537 | |
| 4 | −1.87934 | 0.19958 | | |
| 5 | ∞ | 0.20000 | 1.62230 | |
| 6 | ∞ | | | |

Aspheric surface coefficient

| Surface | | |
|---|---|---|
| No. | 2^{nd} surface | 3^{rd} surface |
| k | 6.94635E−01 | −6.76784E+01 |
| A4 | −1.75896E−03 | −1.18254E−01 |
| A6 | −1.70306E−04 | 3.13135E−01 |
| A8 | −2.73476E−05 | −7.69108E−01 |
| A10 | 5.47073E−06 | 8.79410E−01 |
| A12 | −2.05856E−06 | 3.55792E−05 |
| A14 | 1.83459E−07 | 7.31335E−11 |
| A16 | 6.15036E−09 | 6.05284E−13 |
| A18 | −2.28044E−09 | 1.37739E−14 |
| A20 | 0.00000E+00 | 0.00000E+00 |

| | |
|---|---|
| m | 0.45 |
| m · NA | 0.39 |
| d | 4.62 |
| f | 3.00 |
| d/f | 1.54 |

m: Working magnification of objective lens at the optical
disc thickness of 0.2 mm
d: an axial thickness of the objective lens

Example 8 is of the design wherein numerical aperture NA of an objective lens is 0.85 and a wavelength λ is 405 nm. An amount of generation of spherical aberration caused by a recording position of an optical disc becomes large, because the numerical aperture has a large value. However, spherical aberration caused by the recording position of the optical disc is reduced in this example by adjusting the magnification.

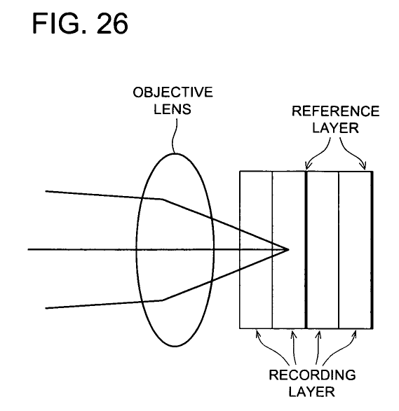

In each of Examples 1-8, there has been used an optical pickup apparatus capable of recording and/or reproducing information on the optical disc that has one reference layer and can record information on positions at different depth of the recording layer. However, it is also possible to employ an optical pickup apparatus capable of recording and/or reproducing information on an optical disc that has plural reference layers and recording layers. The optical pickup apparatus can record information at recording positions each positioned at different depth in each recording layer. In this case, the number of recording layers may also be greater than that of reference layers. Further, a position of the reference layer is not limited to FIG. 26, and it may either be arranged on the surface side of the optical disc for each recording layer, or be arranged on the deepest surface, or be arranged on the intermediate portion of the recording layer.

By arranging the objective lens at a prescribed position in the optical axis direction for any of reference layers, and by changing a convergent angle of a convergent light flux entering the objective lens by displacing a relay lens system in the optical axis direction, an appropriate recording and/or reproducing of information can be carried out for the position in a prescribed depth on a prescribed recording layer.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. An optical pickup apparatus for recording and/or reproducing information on an optical disc comprising at least one reference layer and at least one recording layer in which information can be recorded at a plurality of recording positions each of which is located at a different distance from a surface of the optical disc, the optical pickup apparatus comprising:
a light source for emitting a light flux;
a relay lens system for receiving the light flux emitted from the light source and emitting a converged light flux;
an objective lens arranged at a predetermined distance along an optical axis from the reference layer, for converging the converged light flux from the relay lens system onto one of the plurality of recording positions; and
a photodetector for receiving a light flux emitted from the optical disc,
wherein the relay lens system changes a convergence angle of the converged light flux to enter the objective lens by moving in a direction of an optical axis thereof so as to select a recording position where information is recorded and/or reproduced.

2. The optical pickup apparatus of claim 1,
wherein the objective lens satisfies a following expression:
0.03<m·NA<0.55,
where m is a magnification of the objective lens and
NA is a numerical aperture on an image side of the objective lens.

3. The optical pickup apparatus of claim 2,
wherein the objective lens satisfies a following expression:
0.03<m·NA<0.47.

4. The optical pickup apparatus of claim 3,
wherein the objective lens satisfies a following expression:
0.5<m·NA<0.40.

5. The optical pickup apparatus of claim 1,
wherein the objective lens satisfies a following expression:
0.05<d/f<3.5,
where d is an axial thickness of the objective lens and
f is a focal length of the objective lens.

6. The optical pickup apparatus of claim 5,
wherein the objective lens satisfies a following expression:
0.8<d/f<1.7.

7. The optical pickup apparatus of claim 1,
wherein the optical disc satisfies Ns<Ni,
where Ns is a number of reference layers, and
Ni is a number of recording layers.

8. The optical pickup apparatus of claim 1,
wherein the optical disc includes any one of 1 to 3 reference layers.

9. The optical pickup apparatus of claim 1,
wherein the recording layer of the optical disc includes an aberration-correctable area extending in a direction of a thickness of the optical disc, in which an aberration caused due to a recording-layer thickness from a surface of the optical disc to a recording position is correctable, and
the objective lens converges the converged light flux from the relay lens system with a minimum wavefront aberration at a position in the aberration-correctable area, the position being located at a farther distance in a direction apart from the objective lens than a midpoint of a thickness of the aberration-correctable area.

10. An objective lens for use in the optical pickup apparatus of claim 1.
